(19) United States
(12) Patent Application Publication
(10) Pub. No.: US 2007/0198302 A1
(43) Pub. Date: Aug. 23, 2007

(54) METHOD AND SYSTEM FOR REDUCING THE INCIDENCE OF DEFENSIVE MEDICINE

(75) Inventor: Jeffrey J. Segal, Greensboro, NC (US)

Correspondence Address: FISH & NEAVE IP GROUP;ROPES & GRAY LLP, 1211 AVENUE OF THE AMERICAS, NEW YORK, NY, 10036-8704, US

(73) Assignee: MEDICAL JUSTICE CORP., Greensboro, NC (US)

(21) Appl. No.: 11/425,675

(22) Filed: Jun. 21, 2006

Related U.S. Application Data
(60) Provisional application No. 60/775,574, filed on Feb. 22, 2006.

(51) Int. Cl. G06Q 10/00; G06Q 40/00

(52) U.S. Cl. 705/4; 705/2

(57) ABSTRACT

Methods and systems are described that implement evidence-based schemata in a health care system that embody practice guidelines and/or a standard of care. Physicians in the health care system agree to adhere to the practice guidelines. An insured patient assigns/subrogates the right to sue a physician malpractice to the health insurance carrier and receives medical care in compliance with the practice guidelines. The insured patient may be subject to incentives and disincentives to encourage compliance with the assignment/subrogation agreement. Shielding the physician from lawsuits will give the physician an incentive to abandon the practice of “defensive medicine.” This will significantly reduce the number of diagnostic tests and procedures and associated risks and expenses. Such a system can promote cost-efficiency, increase safety and provide fair remedies to patients who are injured, regardless of the cause.

### CROSS REFERENCE TO RELATED APPLICATION

This claims the benefit of copending U.S. Provisional Patent Application No. 60/775,574, filed Feb. 22, 2006, which is hereby incorporated by reference herein in its entirety.

### BACKGROUND OF THE INVENTION

This invention relates to managing professional liability claims, in particular liability claims from patients against health care providers. More particularly, this invention relates to the provision of setting a cost-effective, evidence-based, predefined standard of care which when followed by the physicians will shield the physicians from tort actions. Tangible benefits may be offered to an insured in exchange for the insured's consent to assign/subrogate claims. Tangible benefits may be also offered to physicians above and beyond immunity from lawsuits.

As society has become more litigious, professionals, in particular in the medical community, have found themselves defending an increasing number of professional liability claims brought by patients unhappy with the quality of the professional services rendered, or with the results of those services. Such services include medical evaluation before any treatment, diagnostic tests and acute and chronic care. Physicians frequently face the accusation of having “missed” a diagnosis for failure to perform a series of exhaustive tests, which, in the eye of the patient, would have changed the clinical outcome. In some cases, such charges of professional misconduct are warranted. However, in many more cases, the charges are unwarranted. Despite competent services rendered at or above the standard of care, concern and attention, and without fault on the part of the professional, the desired result may not be achieved in all cases.

As a result, physicians have been subjected to ever-increasing premiums for liability insurance to defend against such charges of misconduct. As some of these costs must be passed on to consumers (patients), this also has resulted in increased health insurance premiums. More importantly, health insurance premiums for consumers (patients) have risen because of the increasingly widespread practice of “defensive medicine” by physicians seeking to avoid potential allegations by patients that not everything humanly possible was done to avoid an untoward result.

Ideally, physicians (as used herein, unless otherwise indicated, the terms “physician” and “medical care provider” should be interpreted to include any medical practitioner, professional or entity, such as a hospital, that is potentially subject to suit) should provide services, including the administration of diagnostic tests, primarily to care for their patients. However, in defensive medicine, services are provided and tests are administered even when not medically indicated, simply to avoid litigation. In addition, experimental therapies, and treatment modalities that are increasingly sophisticated, requiring trained personnel, special equipment, time and resources are frequently used. However, such care generally does not provide value to the vast majority of patients. On the contrary, such care often exposes the patient to extra risks and adds significant costs to the care with at most marginal potential for positively changing the diagnosis or the outcome of treatment. However, practicing defensive medicine may allow the physician to more successfully defend against allegations that he/she failed to order a potentially vital test or therapy which could have prevented the adverse outcome for the patient.

The practice of defensive medicine is pervasive and costly, and estimated to add between $70 billion and $126 billion per year to the cost of providing health care in the United States. The practice of defensive medicine also is strongly correlated to the practice of medicine in states with perceived “plaintiff- or patient-friendly” tort environments. Not surprisingly, professional liability carriers in these states also charge physicians higher malpractice insurance premiums than in states with “defendant- or doctor-friendly” tort environments. Defensive medicine is likewise more prevalent in states whose physicians, matched specialty for specialty, are being charged higher professional liability premiums. Defensive medicine, then, is seen by physicians not only as a way to reduce the threat of litigation, but also as a way for a professional to satisfy his/her professional liability insurer that he/she is a lower claims risk, in an attempt to avoid even higher premiums.

For these reasons it would be desirable to provide a system that would allow all parties, i.e., patients, health care providers, health insurance carriers and optionally also liability insurance carriers, to participate in a health care system where each party benefits.

### SUMMARY OF THE INVENTION

In accordance with the present invention, appropriate diagnostic procedures and treatments for various medical conditions are established by certain predefined schemata. Use of these predefined schemata preferably creates a rebuttable, or even irrebuttable, presumption that an appropriate standard of care was applied. Agreements between health insurers and their customers (patients) make this standard of care the cost-effective standard to which physicians will be held accountable. Preferably, physicians also participate in those agreements.

An example of such a schema is the “Canadian CT Head Rule for patients with minor head injury,” published in Lancet, No. 357, pp. 1391-96 (May 5, 2001). Frequently, physicians, fearful of missing a treatable lesion after minor head injury, will order a CT scan of the patient's head. Most of these scans show no evidence of a treatable lesion. The Canadian CT Head Rule was developed as highly sensitive decision rules to guide physicians who treat patients with minor head injury. The Canadian CT Head Rule is based on the occurrence of any one of five high-risk factors—failure to reach Glasgow Coma Score of 15 (normal) within 2 hours; suspected open skull fracture; any sign of basal skull fracture; more than two vomiting episodes; age over 65 years—and two additional medium-risk factors—amnesia for events occurring more than 30 minutes prior to impact; dangerous mechanism of injury. In a study on which the rule was based, the high-risk factors were 100% sensitive (95%, acceptably narrow confidence interval range of 92-100%) and 68.7% specific for predicting a need for neurological intervention, and would require only 32% of patients to undergo CT. That is, the use of one or more of these high risk factors as criteria for administering a CT scan in a case of minor head injury allowed the researchers to avoid missing any patients who needed neurological intervention. A second part of the study examined supplementing the high risk factors with the two medium risk factors, so that occurrence of any one high risk factor or medium risk factor would necessitate a CT scan. Use of these criteria demonstrated 98.4% sensitivity (95%, acceptably narrow confidence interval range of 96-99%) and 49.6% specificity for predicting clinically important brain injury, and required 54% of patients to undergo a CT scan. Adding the medium risk factors to the screening criteria did little to improve sensitivity, while lowering specificity and adding to the cost. In any event, use of such a schema (either variant) would focus intervention on those likely to need it, sparing those unlikely to benefit from being subjected to cost-inefficient procedures that also may expose them unnecessarily to radiation.

Thus, in accordance with the invention, if the Canadian CT Head Rule were an accepted schema for diagnosing patients with a head injury, and such a patient were treated in accordance with that rule, the treating physician would be presumed (at least rebuttably) to have acted properly. This would be a defense to a charge of malpractice.

In one preferred embodiment, based on the provision of cost-effective, safe care, a patient agrees to subrogate or assign, to the patient's health insurance carrier, the patient's right to sue for medical negligence. It should be understood that for the purposes of the present invention, subrogation and assignment are indistinguishable, and the reference herein to one is intended to include the other unless the other is explicitly excluded. In exchange for agreeing to subrogate or assign medical negligence claims, the patient may receive as consideration a number of benefits in return. For example, the patient may receive any one or more of a reduction of the patient's health insurance premiums, a subsidy for disability, life or long-term care insurance or such insurance itself (to address untoward outcomes), a guarantee for patient-safety systems, a guarantee of future medical care if rendered care was negligent or grossly negligent, and the like. Finally, the patient may receive at least a portion of any monetary settlement or recovery related to claims that the health insurance carrier, exercising its assigned or subrogated rights, might have against physicians who provided negligent or grossly negligent care. The health insurance premium charged the consumer/patient preferably will reflect the rights foregone as well as any enhanced benefits.

According to the invention, physicians also benefit because they are no longer exposed to the capriciousness of meritless claims that might be brought by a patient, insofar as only the health insurance carrier can file suit. And according to the invention, if a physician follows the evidence-based schemata or guidelines, the physician preferably would have absolute, or at least qualified, immunity from suit, even by the health insurance carrier. That is, a claim would have no merit if advanced against a physician who followed the guidelines. The health insurance carrier, as the owner of a potential claim (by assignment or subrogation) would be forced to adhere to rules to which all parties have agreed. Whereas a patient who was injured might want to advance a claim for a variety of reasons, it is only the health insurance carrier that can advance a claim. If a physician adhered to the guidelines, the rules mandate that such a claim will never be pursued.

Even if the physician did not follow the guidelines, the physician may nevertheless have less exposure than in a case where the patient could sue, depending upon how much benefit/consideration the patient/consumer received in exchange for agreeing to subrogation or assignment. For example, even if a claim has merit because the physician acted negligently and did not adhere to the accepted evidence-based schema determining the standard of care, the heath insurance policy may dictate that the damages be lower (e.g., they may be capped) and/or more predictable. And if the patient/consumer received even more benefit or consideration up front, then even though a claim has merit, the health insurance policy may dictate that it could only be pursued if triggered by a higher threshold, such as gross negligence.

Thus, physicians are encouraged to follow an evidence-based standard of care based on the schemata or guidelines, as it provides qualified or absolute immunity against malpractice lawsuits. Even if a physician fails to follow the guidelines, the frequency or severity of resulting lawsuits will be lower than in the conventional tort system, because the patient selects to a particular threshold for filing a suit (negligence or gross negligence). Moreover, the amount of potential damages may be reduced because the patient may have accepted a particular level of damages depending upon the benefit/consideration selected when the patient agreed to participate in the system.

The invention does not require any agreement on the part of the physician. The physician will simply recognize that a patient has this type of insurance, and knowing that will allow the physician to know that in treating this particular patient, following the schemata will protect the physician. Therefore, the physician will be less likely to practice defensive medicine.

Preferably, however, according to another embodiment of the invention, there also is an agreement between the physician and the health insurance carrier, wherein the physician agrees that care will be guided by an explicit standard of care determined by the evidence-based schemata. By establishing an accepted standard of care to be adhered to by the physicians, health insurance carriers will be able to positively influence physicians to avoid practicing defensive medicine. In doing so, costs will be kept down, and money in the system can be redeployed to provide other benefits mentioned above. As an added incentive, physicians can be paid subsidies, stipends, bonuses, higher compensation or other benefits for consistently adhering to the standard of care determined by the evidence-based schemata.

In short, the needs of each party—i.e., of patients, physicians and health insurance carrier—are met without exposing the parties directly to the costly inefficiencies of the traditional tort system.

In accordance with the present invention, there is provided a method for deterring the practice of defensive medicine by health care providers. The method includes a health insurance carrier defining and disseminating practice guidelines for rendering medical care. The health insurance carrier issues to a patient a plan of health insurance, including securing from the patient subrogation/assignment to said health care insurance carrier of any professional liability claim that arises against any health care provider. The health insurance carrier refrains from asserting any professional liability claim against any health care provider that adheres to the practice guidelines. Preferably, the carrier also has an agreement with the health care provider to adhere to the guidelines.

Apparatus for carrying out the method is also provided.

### BRIEF DESCRIPTION OF THE DRAWINGS

The above and other objects and advantages of the invention will be apparent from the following detailed description, taken in conjunction with the accompanying drawings, in which like reference characters refer to like parts throughout and in which:

FIG. 1 is a schematic diagram showing a closed health care system according to an embodiment of the invention;

FIG. 2 is a flow diagram of a method according to an embodiment of the invention;

FIG. 3 is a graphical representation of benefits derived when medical tests are administered according to accepted practice guidelines;

FIG. 4 is a schematic diagram of an “open” health care system in accordance with another embodiment of the invention; and

FIG. 5 is a schematic view of a preferred embodiment of a hardware system for implementing the present invention.

### DETAILED DESCRIPTION OF THE INVENTION

According to the present invention, practice guidelines or schemata derived from an evidence-based standard of care are established. By “evidence-based” is meant that the standard of care is based on analysis of statistics involving prior patients suffering from similar conditions and the results of various diagnostic procedures and treatments administered to such patients. Such a standard of care is presumed to provide reasonable levels of safety for patients, but also to be cost-effective.

In accordance with the invention, health insurance carriers preferably make these standards of care part of at least one form of coverage offered to prospective insureds (patients/consumers). Any patient who purchases that form of coverage understands and agrees that (1) the patient's right to sue for medical malpractice is subrogated or assigned to the health insurance carrier, and (2) the carrier will not initiate a malpractice action against any medical service provider (e.g., physician) who follows the schemata. In addition to offering such a form of coverage at a lower premium (because of expected overall savings resulting from reducing or eliminating defensive medical practices), the health insurance carrier may offer the subscriber additional incentives as described above and discussed in more detail below.

Just as medical service providers currently recognize various types of patient coverage such as traditional indemnity plans and the various forms of managed care (i.e., HMO, POS and PPO plans), so too will medical service providers learn to recognize plans according to the invention. When a medical service provider encounters a patient who subscribes to a form of coverage in accordance with the invention, the provider preferably will know that defensive medical practices will not be necessary with this patient, as long as the patient's carrier's published schemata are followed.

In another embodiment, health insurance carriers can demand that the schemata be followed. These embodiments apply primarily to managed-care arrangements where health insurance carriers already enter into contracts with medical service providers. In accordance with this embodiment of the invention, such contracts preferably would include a requirement of adherence by the medical service provider to the standards of care embodied in the published schemata. In exchange, the health insurance carrier preferably agrees not to initiate any malpractice action against the medical service provider on a subrogated claim as long as the schemata are followed. Thus, a physician following the guidelines will be shielded from lawsuits by a patient alleging incompetent or inadequate care.

If a physician or other medical service provider does not adhere to the guidelines, and the patient is injured, the provider will be at risk for a lawsuit. A physician may be adjudged to have failed to adhere to the schemata by either (a) failing to comply with the base minimum called for by the schemata, or (b) providing excessive, unnecessary care. Thus, defensive medical practices may actually be a violation of the agreed-upon standard of care. In that sense, there is an optimum window of care that will shield the provider from a lawsuit. In the aforementioned example of the Canadian CT Head Rule, lack of compliance with the guidelines may be found if (a) a physician fails to order a CT of the head after minor injury in a patient with the identified risk factor(s), or (b) a physician orders a CT of the head after minor injury in a patient without the identified risk factors. Failure to comply with guidelines does not mean that there will necessarily be a lawsuit. However, compliance with the guidelines preferably does mean that a lawsuit will be avoided.

The standard of care will include guidelines or schemata for diagnostic procedures as well as guidelines for referral and for treatment. In the aforementioned example of the Canadian Head CT Rule, the rules were developed precisely to balance the competing aims of cost-containment, safety, and fear of litigation.

Defensive medicine, with its ever-increasing effect on rising health care costs, includes the use of diagnostic tests (such as costly imaging procedures), referrals and therapies to avoid being sued for negligence. Such defensive medicine is generally considered to be care that does not have any recognizable benefits for the patient.

However, defensive medicine has other components. For example, out of fear of litigation, a medical service provider may avoid certain high-risk procedures, and also may avoid “problem” patients who are perceived by the provider to elevate the probability of being sued. Thus, for example, physicians have avoided performing procedures prone to complications, such as trauma surgery, and also have avoided patients who have complex medical problems or simply are perceived as litigious. Defensive medical practice correlates strongly with physicians' lack of confidence in their states' tort systems and a perceived threat of higher frequency or severity of lawsuits, higher insurance premiums, and even the reportability of any settled or adjudicated claim against the physician to the National Practitioners' Data Bank (“NPDB”).

Studies have shown that “direct” reforms to the liability system which are designed to reduce, or “cap,” the level of compensation to potential claimants reduce medical expenditures without significant negative consequences for patient health outcomes. However, this approach, while helpful, perpetuates the present liability system, leaving medical care providers exposed to lawsuits. That is, a capped settlement may be associated with a lower payout to a plaintiff patient. But the physician (or other provider), while gaining the benefit of lower professional liability insurance premiums, is still exposed to the stress of a lawsuit, with all its effects on the physician's practice, personal life and reputation. Because the risk of frequency of lawsuits is not significantly changed by direct tort reforms, such reforms have not dramatically changed physician behavior in terms of how they practice medicine. Physicians at risk for being sued, even for lower awards or judgments, still practice defensively. Because medical care providers still perceive a need to practice defensively, cost savings from direct tort reforms are not as significant as they could be. If physicians were shielded from not only the severity but also the frequency of lawsuits, they could practice in ways that lower overall systemic costs, thereby lowering premiums for both professional liability insurance (for themselves) and health insurance (for patients).

For a system according to the invention to achieve its goal of substantial cost savings, it must be acceptable to the public who buy health insurance (or who receive it from employers) that they give up the right to sue for malpractice. Therefore, the system preferably includes incentives for the patient. First, the system preferably assures a patient that he/she can expect to receive medical care according to an accepted standard of care adhered to by the treating physician. Other benefits include a reduction in health insurance premiums. In addition, the health insurance policy may be coupled with a disability and/or long-term care policy for patients whose injuries result on long-term disabilities. Life insurance may be offered to dependents or named beneficiaries. In addition, should there be a recovery by a carrier against a physician, some or all of that recovery might be transferred to the patient, the patient's estate, or a named beneficiary.

The physician remains free to prescribe and administer any suitable diagnostic tests as determined by professional judgment. However, to control expenses, the evidence-based schemata according to the accepted standard of care for arriving at a diagnosis and/or treatment would recommend certain tests. Any additional “defensive” tests would not be expected to change the medical outcome for the patient and would therefore not be expected to be administered on a routine basis. In the event of litigation (brought by the health insurance carrier, not the patient), the physician would have to justify departure from the schemata if any additional tests were administered.

The following table compares various systems to illustrate the present invention. The benefits for the health care system depend on the physician's compliance with the diagnostic and treatment schemata and on the threshold for bringing legal action against a physician. The diagnostic and treatment schemata preferably do not depend on a single factor, such as an actual diagnosis, but also take into account other parameters, such as a patient's overall health, age, genetic factors, etc.

| | | | Physician | | | |
|---|---|---|---|---|---|---|
| | | | Compliance | | | |
| | | | With | | | |
| | | Cost of | Diagnostic | | | |
| | | Health | and | | Threshold | |
| | | Insurance | Treatment | Subrogation/ | for | Remedy to |
| | | Premium | Algorithms | Assignment | Physician | Patient/ |
| | System | (Rank) | (Rank) | to Carrier | being Sued | Carrier |
| A | Traditional | 6 | 1 | None | Threshold: | Claims are |
| | Tort System | (highest) | | | negligence | for economic, |
| | | | | | | non-economic, |
| | | | | | | and punitive |
| | | | | | | damages. |
| B | Subrogation | 5 | 2 | Assignment | Threshold: | Claims are |
| | “Lite” | | | of rights to | negligence | for economic |
| | (Minimum) | | | carrier | | damages and a |
| | | | | | | cap for non- |
| | | | | | | economic |
| | | | | | | damages. |
| | | | | | | (can be at |
| | | | | | | multiple |
| | | | | | | levels) |
| C | Subrogation | 4 | 3 | Assignment | Threshold: | Claims are |
| | “Lite” | | | of rights to | negligence | for economic |
| | (Maximum) | | | carrier | | damages only |
| D | Subrogation | 3 | 4 | Assignment | Threshold: | Claims are |
| | Major | | | of rights to | Gross | for economic, |
| | (Minimum) | | | carrier | negligence | non-economic, |
| | | | | | | and punitive |
| | | | | | | damages. |
| E | Subrogation | 2 | 5 | Assignment | Threshold: | Claims are |
| | Major | | | of rights to | Gross | for economic |
| | (Medium) | | | carrier | negligence | damages and a |
| | | | | | | cap for non- |
| | | | | | | economic |
| | | | | | | damages. |
| | | | | | | (can be at |
| | | | | | | multiple |
| | | | | | | levels) |
| F | Subrogation | 1 | 6 | Assignment | Threshold: | Claims are |
| | Major | (lowest) | | of rights to | Gross | for economic |
| | (Maximum) | | | carrier | negligence | damages only |

System A is the traditional tort system, while Systems B-F are various forms of the invention. In Systems B-F, the health insurance carrier (via subrogation or assignment) controls or owns the right to sue the medical service provider. The carrier might receive a settlement or award from the physician. The plan might provide that the carrier transfer none, some, or all of that settlement or award to the patient (or—e.g., if the patient does not survive—his family or designee). The patient would be expected to pay a lower health insurance premium if the plan provided that none of the settlement or award would be transferred to the patient, and a somewhat higher health insurance premium to preserve the right to receive some or all of the settlement or award.

The most expensive system (A), in terms of both health insurance premiums for the patient and potential monetary awards for injuries allegedly sustained by the patient, is the traditional tort system where the patient has not subrogated any rights and is able to file claims against a physician for economic, non-economic, and punitive damages in the event of negligence, and often recovers damages without actually proving negligence (e.g., through settlement). The physician may not be able to rely definitively on any accepted evidence-based standard of care, and the burden of proof that no negligence occurred may as a practical matter (if not legally) fall on the physician. The physician will therefore want to protect him- or herself from lawsuits by practicing defensive medicine as described above, ordering diagnostic tests in excess of those specified in the schemata based on the accepted cost-effective, evidence-based standard of care.

Conversely, a patient will pay the lowest health care premium in a system (F) where the insured has assigned all rights to the health insurance carrier, where the physician agrees to adhere to the diagnostic and treatment schemata defined by the practice guidelines, where the threshold for bringing a lawsuit is gross negligence, and any lawsuit brought by the assignee carrier will be merely for economic damages. In this case, the patient's claims, which were assigned to the health insurance carrier, will be limited to economic damages only, and will be paid to the health insurance carrier. In other words, the insured can choose the lowest possible premium and thereby opt out of any direct settlement or award, even for injuries related to gross negligence. In this system F, the health insurance carrier, as the assignee of the patient's rights, might transfer none, some, or all of the economic damages awarded to the patient. The lowest health insurance premium for the patient would be based on the carrier keeping all of the award and transferring none of that award to the patient. The patient would pay a somewhat more expensive health insurance premium for a policy under which the carrier will transfer some or all of any settlement or award back to the patient. Regardless of the variety of system F chosen by the patient, system F is the least expensive because any settlement or award would be for economic damages only and would be based on a gross negligence threshold.

Under systems E and D, where the threshold is still gross negligence, damages could include (limited) non-economic damages (system E) or even punitive damages (system D) in addition to economic damages. As expected, such systems result in lower overall savings. The insured would pay a higher premium and at least some non-economic and even punitive damages may be awarded to the carrier. Preferably, such damages would be capped at, e.g., $250,000 for non-economic damages. That number is considered by many physicians to be a desirable limit and is a common standard for non-economic damages in states that have pursued tort reform. However, even under such a system, there still may be significant savings as compared to the traditional tort system (A). Again, the carrier, as the assignee of the patient's rights, might transfer none, some, or all of the economic damages and capped or uncapped non-economic damages, whether received from a settlement or award, to the patient. The higher the amount that could potentially be transferred, the higher the patient's premium would be.

Somewhere in the middle are systems (B, C) in which patients would subrogate or assign potential claims to the health insurance carrier, and medical service providers would be expected to adhere to the evidence-based standard of care embodied in the carrier's schemata or guidelines. In these systems, damages are more limited than in the traditional tort system (A), but the lawsuit threshold where the standard of care was not adhered to remains ordinary negligence. In these systems, the damages are lower than they would be in the traditional tort system (system A). But because the lawsuit threshold is unchanged from system A, the frequency of lawsuits will be similar to the status quo. On the other hand, the severity of lawsuits (as measured by size of judgments or settlements) will be lower. Because the frequency of lawsuits will not be significantly decreased, the physician will continue to practice in fear of being sued. Accordingly, the physician will be less likely to adhere to the evidence-based standard of care embodied in the schemata by performing a minimum number of tests. More likely, the physician will instead be inclined to practice some level of defensive medicine. Accordingly, such systems, while presenting some savings, are less likely to achieve the same reduction in defensive medical practices as systems D-F.

In exchange for assigning his/her rights to the health insurance carrier, the patient receives care in accordance with schemata guided by an accepted evidence-based standard of care. The carrier and not the patient may recover damages directly only if the physician acted with ordinary or gross negligence. Rules agreed to by the carrier and patient will determine how much, if any, of those damages might be transferred back to the patient.

It should be noted that there is no way to absolutely stop an aggrieved patient from attempting to file a lawsuit notwithstanding the assignment/subrogation agreement. However, the patient may be subject to disincentives if he/she attempts to ignore the terms of the assignment/subrogation agreement and attempts to initiate a lawsuit. For example, the patient may be subject to any one or more of liquidated damages, attorneys fees, denial of continued medical insurance coverage, and combinations thereof.

The invention thus produces substantial overall cost savings for the health care system by giving the physicians an incentive to forego, or at least reduce, the practice of defensive medicine. It will be understood, however, that the patient, by purchasing an insurance product in accordance with the invention, would have to agree, in exchange for a lower premium, to subrogation or assignment of claims, and to the tort threshold that would be applied in determining liability (e.g., “negligence” or “gross negligence”). The patient may also have to agree to amounts for which the physician would be liable—e.g., economic damages only, economic damages plus capped non-economic and/or punitive damages, etc. The patient would further have to agree whether any damages potentially recovered, which would belong to the carrier, would be transferred to the patient. Even if the patient buys a policy that does not transfer any of the damages, the patient may still be asked to select the tort threshold, because the patient may feel “safer” or “less safe” knowing that the physician will be held to a certain threshold.

The method of the invention preferably would:

1. Decrease exposure of physicians to the tort liability system (by decreasing the frequency and/or the severity of lawsuits);

2. Provide an incentive to physicians to not practice defensive medicine;

3. Make the health care system safer for patients by reducing risks from unnecessary procedures and tests;

4. Make the health care system safer by freeing up wasted money to implement patient safety systems in doctor's offices, hospitals, etc., as described below.

5. Provide varying levels of damages for a patient's injuries, from no damages at all, to a transfer of some or all of the damages from the health insurance carrier to the patient. Supplemental coverage might be provided in the form of disability, life and/or long-term care insurance paid for at least in part by the carrier to provide a remedy for injury to the patient.

In particular, the health insurance carrier, having received the assigned/subrogated rights may do one or more of the following for an injured patient:

1. Provide the patient with benefits up-front in the form of lower health insurance premiums. However, not compensating the patient for even actual economic damage (such as lost wages) may require significant consideration. However, there are precedents for requiring patients to forego all of their rights to sue for medical negligence (such as active duty military personnel).

2. Provide the patient with supplemental coverage in the form of subsidized or fully-paid disability, life and/or long-term care insurance in the event of injury. These benefits would presumably “make the patient whole” and would be provided outside of the tort system. There could be gradation of such supplemental policies, depending on the level of premium paid. The most unrestricted supplemental policy, once issued, would pay benefits regardless of whether occurrence of the event insured against under the supplemental policy is the result of treatment for a condition covered by the underlying health insurance policy. A more restrictive supplemental policy would pay benefits only if the event insured against under the supplemental policy is associated with a condition being treated by a physician under the underlying health insurance policy, but regardless of fault. A more highly restrictive supplemental policy would pay benefits only if the event insured against under the supplemental policy is associated with a condition being treated by a physician under the underlying health insurance policy and the physician did not adhere to the appropriate schema, whether or not that amounted to any form of negligence. A most restrictive supplemental policy would pay benefits only if the event insured against under the supplemental policy is associated with a condition being treated by a physician under the underlying health insurance policy, the physician did not adhere to the appropriate schema, and that failure to adhere to the schema amounted to a specified type of negligence (ordinary or gross). Other gradations may be possible.

3. Provide the patient with additional medical care or paid-up health insurance premiums. This benefit might be provided, e.g., only for an injured patient who can no longer work and therefore can no longer pay for insurance, or might be provided whenever the physician violated a schema (paid for, e.g., by damages recovered from the physician by the health insurance carrier).

4. Provide the patient with some or all of the settlement or judgment received from the medical care provider.

This would result in:

1. Lower health insurance premiums, thus making health insurance more affordable and decreasing the number of uninsured or underinsured patients.

2. Lower costs related to defending physicians, because the assignment/subrogation would prohibit lawsuits for care that complies with the accepted evidence-based standard of care embodied in the schemata, and will reduce the frequency and/or severity of lawsuits alleging negligent care.

3. Freeing up of capital within the health care system to implement substantive patient safety systems.

Although the assignment/subrogation of rights, and the high threshold for suing a physician, in accordance with the invention should encourage physician compliance with the diagnostic and treatment schemata, which should reduce the expensive practice of defensive medicine, there is no way to absolutely prevent an aggrieved patient from filing a lawsuit, notwithstanding any agreement the patient may have made with the health insurance carrier. However, the assignment/subrogation provisions of the policy may also includes provisions to dissuade the patient from initiating individual legal action against a physician. Such provisions may include patient/insured liability for liquidated damages or attorney's fees, cancellation of medical coverage, and the like, in the event of the filing of a lawsuit, which would be a breach of the insurance contract.

Subrogating or assigning claims to the health insurance carrier will remove a claim by a patient from the traditional tort system. In medical malpractice cases, the traditional tort system aims to deter negligence and to make the injured patient whole. Many believe it does neither well. There are no data supporting the contention that states which limit damages (with caps on non-economic damages, for example) encourage progressively higher levels of ordinary negligence. Hence, it is unclear that the threat of litigation, in it of itself, makes patients safer. Further, the tort system dispenses remedies unequally. Two individuals in the same state with the same injury are likely to receive a different remedy. Both will require significant resources to prove their claims. And it will likely take years to receive their remedies, if any are received at all. Hence, the traditional tort system fails to achieve either of its major goals. The present invention does not ignore those goals. On the contrary, it frees up funds to potentially (a) implement patient safety systems—systems that health systems currently view as expensive and not contributing to their bottom line; and (b) provide subsidies for disability, life or long-term care insurance policies which can provide predictable funds to injured patients or their families relatively quickly without the burden of having to prove fault or negligence. Finally, because the blame experienced by any one physician is decreased, all physicians are encouraged to disclose openly and honestly when they make mistakes or experience “near-hits.” Such disclosure makes it more likely that system flaws can be identified in a timely fashion and corrected for the future.

Model systems in accordance with the invention will now be described.

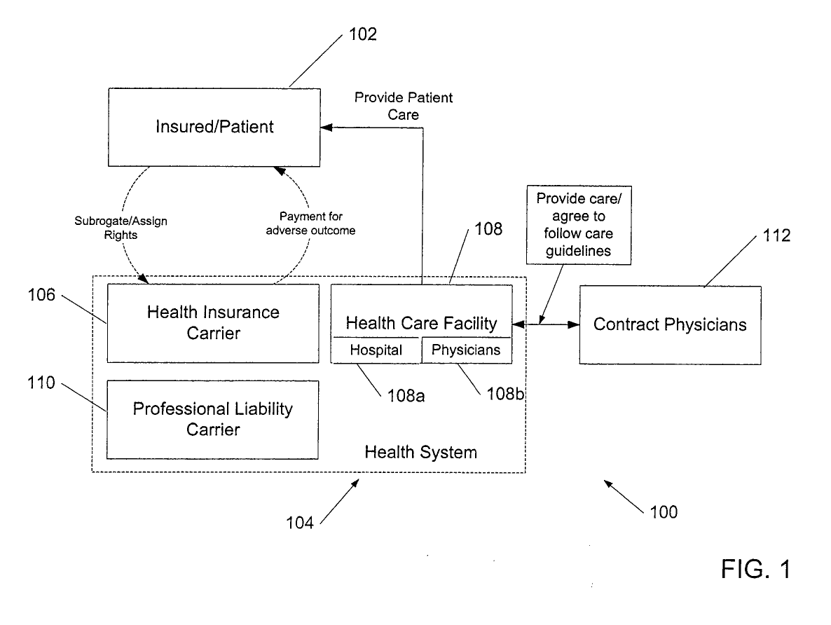

FIG. 1 illustrates schematically an exemplary “closed” system 100 where individuals 102 purchase health insurance coverage from a captive health insurance carrier 106 that is part of an integrated corporate health care system 104. Health care system 104 may include a health care facility 108, such as a hospital 108a, that employs physicians 108b. The health system 104 may also contract with other physicians 112 and other health care facilities. In the exemplary “closed” system 100, the health insurance carrier 106 sets and enforces practice guidelines or schemata to which the caregivers 108, 108a, 108b and 112 must adhere if they wish to participate in health care system 104 and receive reimbursement for their services from health insurance carrier 106. Health care system 104 may also include a captive professional liability carrier 110 to which the physicians 108b, 112 directly or indirectly pay a premium for professional liability insurance.

As described below, patients participating in the exemplary closed system 100 will have assigned/subrogated their rights to directly sue a physician. The professional liability carrier 110 may pay a claim for malpractice to the health insurance carrier 106 (normally after litigation or by settlement). Such a subrogated/assigned claim might be triggered based on a physician 108b, 112 failing to adhere to evidence-based guidelines or schemata. Another threshold for advancing such a claim may be either ordinary or gross negligence. The maximum amount of that claim may vary from (a) economic damages only to (b) economic damages plus capped non-economic damages to (c) economic damages plus capped or uncapped non-economic and punitive damages.

Health care system 104 may or may not be self-insured for malpractice liability of its employees (including physicians and others), which may involve ownership of professional liability carrier 110. If system 104 is self-insured, it may or may not purchase liability insurance to cover events exceeding a certain damage award (stop-loss insurance or reinsurance).

In the closed system 100 of FIG. 1, a patient 102 preferably would purchase health insurance from health insurance carrier 106 and preferably would assign/subrogate to health insurance carrier 106 his/her right to directly sue a physician for negligent or grossly negligent care. The carrier 106 would then have the right to pursue a claim for malpractice against physician 108b, 112. In accordance with the provisions of a particular policy purchased by patient 102, the carrier may transfer some or all of any award/settlement from the physician (paid by the professional liability carrier 110). Whether the policy provides for any such transfer, and what portion of the award or settlement is transferred, will in part determine the premium paid by patient 102. As noted, the bar for any such suit would be based on a specific threshold, which could be either ordinary negligence or gross negligence (e.g., willful conduct).

Preferably, all physicians participating in the closed system 100 will have agreed to, and undergone training to administer tests and perform procedures in conformance with, the practice guidelines and diagnostic and treatment schemata. Indeed, as a group, they may have substantive input into developing the agreed-upon guidelines. As long as the physicians adhere to these guidelines, they will be defended against any direct lawsuits by health insurance carrier 106. Because a physician who follows the practice guidelines will feel less threatened by a lawsuit, he/she will also have less incentive to perform unnecessary tests and procedures—i.e., he/she will refrain from practicing defensive medicine. In addition, the physician might receive other tangible benefits from the carrier for complying with the guidelines, such as bonuses, additional compensation, and the like. Such compliance could be measured by audits and the benefits conferred would be based on how well the guidelines were followed, as determined by an established metric.

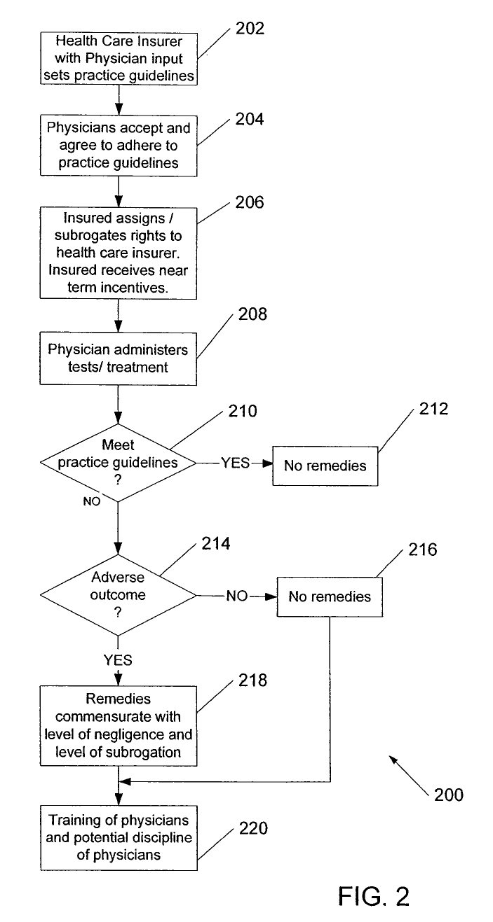

FIG. 2 shows in the form of a process flow chart an exemplary process 200 for administering a system such as system 100 of FIG. 1. At step 202, the health care insurer (preferably with physician input) sets practice guidelines or defines diagnostic and treatment schemata, and the physicians participating in the health system agree at step 204 to follow the guidelines. As a result, a patient can be reasonably assured to receive proper treatment provided that the guidelines are followed. At step 206, an insured/patient assigns/subrogates his rights and agrees that no lawsuit will be brought in his/her name directly or indirectly (e.g., for loss of consortium by a spouse) in the event of an adverse outcome of a treatment. Any claims that could be pursued if the physician did not follow the guidelines would be via the health insurance carrier, as the assignee of any claim (or owner/controller of subrogated rights to make a claim) against the physician.

After assigning/subrogating his/her rights at step 206, the patient will not have any direct cause of action against the physician should he/she be injured. The patient may receive one or more of the following forms of consideration for the assignment/subrogation: (a) lower health insurance premiums; (b) a subsidy for disability, life or long-term insurance; and/or (c) a guarantee that funds are recycled into systems that support or promote patient safety. Further, the health insurance carrier might continue to provide payment for general coverage for the injured patient for some time period in the future (i.e., the carrier might provide continued coverage without the injured patient having to pay additional premiums in the future).

At step 208, the physician in performing his/her duties administers certain tests in compliance with the diagnostic and treatment schemata—i.e., commensurate with a particular diagnosis and set of circumstances (such as the patient's overall health, age, etc.). If all tests and/or treatment meet the guidelines, as determined at test 210, then the patient (or the health insurance carrier on the patient's behalf) would have no cause of action against the physician even if the patient were injured (step 212).

Conversely, if it is determined at test 210 that the tests and/or procedures do not meet the guidelines, and involve negligence or even gross negligence on the part of the physician, but the patient was not harmed (test 214), then the patient would not be entitled to any remedies (step 216). However, the physician may be reprimanded, suspended or expelled, or otherwise disciplined, or be required to undergo additional training on the practice guidelines (step 220).

If the physician acted with ordinary or gross negligence and the patient was harmed (test 214), then the health insurance carrier, as the successor by subrogation/assignment to the patient's potential malpractice claim, may bring suit against the physician (step 218). The threshold for liability on the part of the physician will be ordinary or gross negligence, depending on the patient's policy—i.e., on the nature of the subrogation agreement or assignment, and on the amount of any additional benefits that the patient may have received up front. Similarly, the portion of any damage award or settlement received by the health insurance carrier that is ultimately transferred to the patient, if at all, would depend on the policy as well. It should be remembered, however, that the health insurance carrier's interest in filing suit against the physician is primarily to be reimbursed for medical expenses in treating the injured patient. Thus, the health insurance carrier would normally not be interested in suing for pain and suffering, lost wages, or the like, which are likely to be excluded by the subrogation agreement or assignment. Again, the physician may require additional training and updating on the practice guidelines (step 220), and the process ends.

It is evident that in process 200 few, if any, remedies are available to a patient alleging improper care if the physician follows the established practice guidelines and treatment schemata. As the physician benefits from substantial immunity by adhering to the guidelines, this will entice the physician to refrain from practicing “defensive medicine.”

In the closed system of FIG. 1, physician care is easily tracked and negligent care is easily documented. To the extent such care can be addressed by patient safety systems, such experiences will serve as examples as to what systems need to be implemented. The implementation of such systems may be paid for from the cost savings resulting from the decreased practice of defensive medicine. Further, should certain individual physicians be determined to present a continued “danger” to patients (for example, due to gross negligence or even willfulness), they may be disciplined, have their privileges curtailed or suspended, or, in rare cases, be terminated. Although these outcomes are little different from the results of standard peer review performed by hospitals or medical licensing boards, in the closed system of FIG. 1, there will be more incentive to locate and publicize deficiencies in the system to improve safety for all patients, because all participants benefit directly or indirectly from exposing deficiencies and acting with candor. For example, physicians may be more open about mistakes, which may improve procedures for the future, if they have less fear of being subject to litigation.

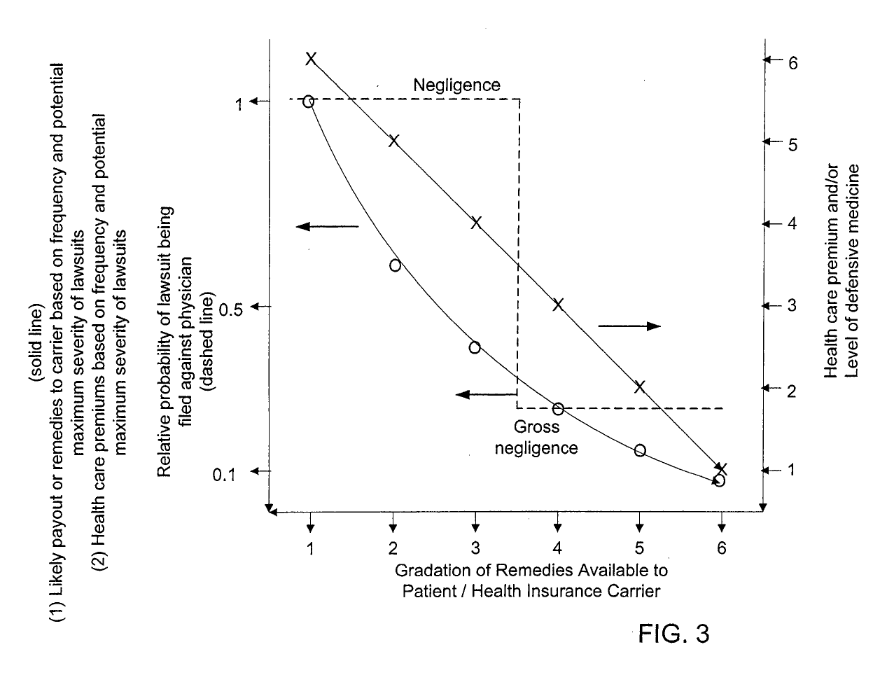

FIG. 3 is a schematic diagram that illustrates the benefits realized in a closed system of the type illustrated in FIG. 1, in which patients are assumed to have assigned/subrogated their rights, and physicians practice in accordance with accepted schemata that implement evidence-based practice guidelines. The diagram shows the interrelationship among the following variables:

(a) The remedies for damages available to a patient or the carrier (plotted on the x-axis) on a scale from 1 to 6, as described with reference to the foregoing table. “1” reflects the traditional tort system, including the availability of unlimited recovery for economic and non-economic injury, plus punitive damages based on a threshold of ordinary negligence, “6” reflects the availability of recovery for only economic damages, based on threshold of gross negligence;

(b) the patient's savings (plotted on the right-hand y-axis) in health care premium, for example. (other substantial savings and incentives could be provided); and

(c) the probability of a lawsuit being filed against a physician (plotted on the left-hand y-axis). The right-hand y-axis of FIG. 3 also reflects the level of defensive medicine—i.e., the lowest premiums are associated with the lowest levels of defensive medicine. It will be understood that these curves are intended only to indicate a general trend and not to represent any quantitative monetary value.

The dashed curve in FIG. 3 indicates a relative probability for ordinary negligence as compared to gross negligence. Gross negligence can be expected to occur much less frequently, is more easily detected, and can be dealt with more quickly through—e.g., suspension of a physician's privileges—than ordinary negligence. In the depicted example, ordinary negligence is assumed to occur with a relative probability P₀ (P₀ here is normalized to 1) and gross negligence with a relative probability of ¼P₀ or 0.25 (normalized). According to the foregoing table and shown graphically in FIG. 3, varying a physician's susceptibility to damage remedies from 1 to 3 as noted on the x-axis will reduce the remedy available to an injured patient/carrier by first eliminating punitive damages (“#2” on the graph) and then placing a cap on non-economic damages (“#3” on the graph). Significant benefits are achieved in the health care system of the invention by elevating the threshold for bringing a lawsuit against the physician from ordinary negligence to gross negligence, which occurs much less frequently.

The rules in the schemata may not be absolute, and some judgments may need to be made even when following the schemata. Therefore, to minimize the risk of a physician being sued and thus realize the maximum savings to the system, a “gross negligence” standard should be applied. If ordinary negligence were be to used as the standard, pain and suffering preferably would need to be capped at a level far lower than currently available in many states. Hence, at the very least, physicians and/or hospitals would save money on their professional liability premiums, although there would be less incentive to avoid practicing defensive medicine under the ordinary negligence standard.

The savings generated by the increased efficiency of a system in accordance with the invention could be used to perform one or more of the following:

1. Recycle the surplus funds into patient-safety systems. Examples include automated prescription systems, computerized calling systems to notify patients of lab results, educational sessions addressing same site surgery;

2. Lower health insurance premiums for the consumer;

3. Subsidize, in whole or in part, life, disability or long-term care insurance policies for the insured. Such policies would at least partially compensate injured patients for economic loss;

4. Set up an insurance pool to guarantee future health insurance coverage for those who are negligently injured, at no or little cost to the insured;

5. Other subsidies or services to the consumer, such as mental health benefits, maternity coverage, or subsidies or discounts for health-related services such as health club memberships;

6. Higher reimbursement or salaries for physicians, so that they practice more as “team players.”

In general, the health insurance carrier will have little incentive to sue physicians who acted negligently, but who are otherwise competent and provide services on a daily basis, because such legal action might alienate the physicians and other health care providers in the system. The health insurance carrier, by shielding the physicians from legal action, may therefore further encourage them to avoid practicing defensive medicine. Thus, while prior attempts to discourage the practice of defensive medicine have not been greatly successful, the system of the invention may achieve that result in at least two ways.

The health insurance carrier might still sue the physician if a higher threshold of negligence is met—e.g., gross negligence or recklessness (willfulness). In such circumstances, the health insurance carrier might transfer some or all of the settlement or judgment received from the liability carrier to the injured patient in accordance with the terms of the insurance policy and the subrogation agreement/assignment.

As a further benefit of the present invention, because the payouts related to legal defense, settlements or judgments in the closed system of FIG. 1 would be lower than with a traditional tort system, the premiums paid by physicians and/or hospitals (directly or indirectly) to their liability carriers also may be lower.

In accordance with the invention, any payment related to malpractice would be made only and directly to the health insurance carrier, as the plaintiff, as opposed to the patient. The patient would be made whole, within the limits of his/her coverage, by the health insurance carrier. This might also sidestep the issue of reportability to the National Practitioners' Data Bank. Currently, a physician who settles a case, or loses a verdict and pays a judgment to a patient, is reported to the NPDB. If payment is made to some other legal entity, such reporting is avoided. Physicians often litigate cases that should be settled primarily to avoid being reported to the NPDB.

In a closed system such as that depicted in FIGS. 1 and 2, the savings associated with minimizing the practice of defensive medicine would be expected to be far greater than the sums a carrier could collect under its assigned/subrogated rights, even if the traditional threshold of ordinary negligence is applied. Hence, a more profitable strategy for the carrier would be to use its assigned/subrogated rights primarily to reduce its expenditures (e.g., by having its employed or contracted physicians practice less defensive medicine) rather than to sue physicians to increase its revenue.

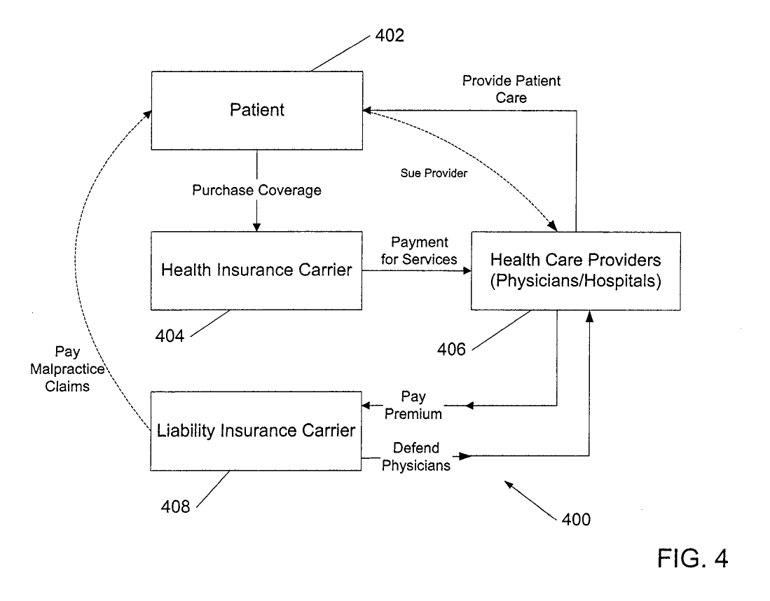

FIG. 4 illustrates an alternative embodiment of the invention in which the health care system 400 is “open.” In system 400, unlike in the “closed”system 100 depicted in FIG. 1, health care is not delivered within the context of an integrated corporate system. Here, consumers/patients 402 purchase health insurance coverage from a third party health insurance carrier 404. Health care providers 406, including physicians and hospitals, are independent entities providing services to patients 402. The physicians, hospitals and other health care providers 406 may have negotiated rates as part of a contract with the health insurance carrier 404 for delivery of specific medical services, such as tests and treatments. In the open system 400, the physicians, hospitals and health care providers 406 may purchase liability insurance from a third-party professional liability carrier 408 to defend against lawsuits alleging medical malpractice.

In open system embodiment 400, the health insurance policy purchased by a patient 402 may still include an assignment/subrogation of malpractice claims. Such an assignment/subrogation would be associated with liability insurance carrier 408 paying malpractice claim to health insurance carrier 404 based on rules and limits established in insured patient's (402) policy. And health insurance carrier 404 would still publish guidelines and schemata for diagnosing and treating various conditions. Thus, even though physicians and other providers 406 may not be employed by health insurance carrier 404, the physician or provider 404 still would know that if a patient is insured under that type of policy (as would be known in the industry just as providers now recognize the various forms of indemnity and managed care health insurance and act accordingly), then he/she would have at least some immunity from suit by following that insurer's published guidelines. Thus, physician/provider 406 could safely practice less defensive medicine when caring for such patients, even though other patients with other forms of insurance may be subject to defensive medical practices by that same physician/provider 406. In a further variant of open system 400, similar to current managed care plans, there may be contract between physician/provider 406 and health insurance carrier 404 that formalizes the physician/provider's immunity from suit as long as the published schemata are followed.

An open system 400 is expected to provide less savings than the closed system 100, because each physician/provider 406 is exposed to patients who do not participate in or have opted out of the assignment/subrogation type of policy contemplated by the invention. Although ideally physician/provider 406 would exercise the same level of care with all patients, physician/provider 406 may still practice some degree of defensive medicine because of the possibility that some patients can still directly sue physician/provider 406. This particularly would be the case where the patient carried health insurance that does not include, or that the physician/provider 406 does not recognize as including, the assignment/subrogation/immunity feature.

In a further variation of either a closed system or an open system, the evidence-based schemata can be varied. Some of these variations might be perceived to be more defensive than others, but would still provide cost savings over the traditional medical system. Thus, the closed system might allow for two standards of care for closed head injury. In one, the sensitivity for using CT scans for minor head injury to recognize treatable brain injuries will be targeted at 99%. In the other, the sensitivity for using CT scans for minor head injury to recognize treatable brain injuries will be targeted at 99.9%. The first variation allows for missing one lesion in a hundred. The other variation allows for missing one lesion in a thousand. The frequency of using CT scans for minor head injury will have to increase to achieve this more restrictive constraint. The target of sensitivity of 99.9% can be viewed as “more defensive” than sensitivity of 99%. Nonetheless, in this context, both 99% and 99.9% might be quite reasonable targets.

In such an embodiment which includes a range of schemata or standards of care (each standard being reasonable), there will be gradations of progressively less defensive medicine. The savings associated with such a system can be passed on to a patient/insured depending on which standard the patient/insured chooses. Such savings might include more progressively lower health insurance premiums, larger subsidies for disability or life insurance, greater expenditures for patient safety systems, etc.

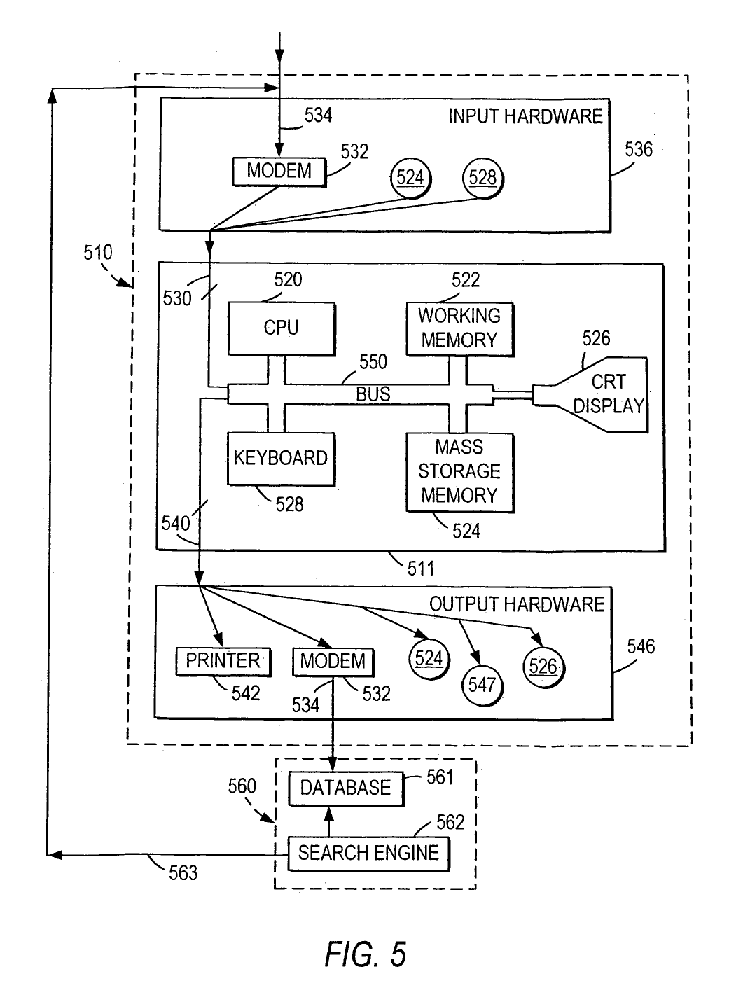

An exemplary computer hardware system 510 with which the present invention may be implemented is shown in FIG. 5. In FIG. 5, which shows a preferred embodiment of apparatus according to the invention, system 510 includes a computer 511 comprising a central processing unit (“CPU”) 520, a working memory 522 which may be, e.g., RAM (random-access memory) or “core” memory, mass storage memory 524 (such as one or more disk drives or CD-ROM drives), one or more cathode-ray tube (“CRT”) display terminals 526, one or more keyboards 528, one or more input lines 530, and one or more output lines 540, all of which are interconnected by a conventional bidirectional system bus 550.

System 510 can be used to take applications and issue policies. System 510 can also be used to keep track of the receipt of signed assignment/subrogation agreements from patients/consumers who purchase policies. In the event of a patient injury resulting a claim against the physician or other health care provider, system 510 can be used to track the claim. If a determination is made (see FIG. 2) that a relevant practice guideline has not been followed, resulting in an entitlement to sue, the litigation can be tracked and, in the event of a settlement or award, system 510 can be used to make any payment to which the health insurance carrier or patient may be entitled or to administer any other policy, such as a life, disability or long-term care policy, or period of free medical care or paid up health insurance premiums, to which the patient may be entitled as a result of the injury.

Input hardware 536, coupled to computer 511 by input lines 530, may be implemented in a variety of ways. Modem or modems 532, which also may be routers or other computer-to-computer communications devices, connected by a telephone line or dedicated data line (such as a T1 or T3 line) 534 can be used to allow direct dial-up access. Modems/routers 532 also may be used to allow access from the Internet. Alternatively or additionally, the input hardware 530 may comprise CD-ROM drives or disk drives 524. In conjunction with display terminal 526, keyboard 528 may also be used as an input device. For example, application data, underwriting data from an underwriter, or guideline adherence data from a reviewer, may be entered through one or more keyboards 528.

Output hardware 546, coupled to computer 511 by output lines 540, may similarly be implemented by conventional devices. By way of example, output hardware 546 may include CRT display terminal 526 for displaying, e.g., the premium to be charged or whether or not an application is approved or a lawsuit is authorized against a health care provider. Output hardware 546 might also include a printer or other printing device 542, so that hard copy output may be produced, or a disk drive 524, to store system output for later use.

Output hardware 546 preferably also includes a payment unit 547 for disbursing funds to health insurance carriers or patients who are entitled to payment of part or all of an award as discussed above. Payment unit 547 could be a check printer if payment is made by check. Alternatively, payment unit 547 could be an electronic funds transfer unit that, using modem/router 532, communicates with the carrier's bank and the patient's bank to transfer funds directly to the patient's account.

In operation, CPU 520 coordinates the use of the various input and output devices 536, 546, coordinates data accesses from mass storage 524 and accesses to and from working memory 522, and determines the sequence of data processing steps.

In summary, methods and systems are described which first and foremost provide an insured with medical care that complies with accepted evidence-based practice guidelines and follows defined diagnostic and treatment schemata. The patient would assign/subrogate claims in exchange for pecuniary benefits, such as lower health insurance premiums. A physician/provider who adheres to the established practice guidelines would be largely shielded from lawsuits. With the lessened threat of legal action, the physician would then be less inclined to practice “defensive medicine,” which would in turn significantly reduce the overall health care costs without diminishing the quality of medical care.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A method for deterring practice of defensive medicine by health care providers, said method comprising:
a health insurance carrier defining and disseminating practice guidelines for rendering medical care;
said health insurance carrier issuing to a patient a plan of health insurance, including securing from said patient subrogation/assignment to said health care insurance carrier of any professional liability claim that arises against any health care provider; and
said health insurance carrier refraining from asserting any professional liability claim against any health care provider that adheres to said practice guidelines.

2. The method of claim 1 wherein said subrogation/assignment prevents the patient from suing the physician directly.

3. The method of claim 1 wherein the subrogation/assignment allows the health insurance carrier to sue the health care provider in the event of negligence on the part of the health care provider.

4. The method of claim 3 wherein the health insurance carrier recovers from the health care provider at least a defined limit of damages suffered by a patient and sustained due to negligence by the health care provider.

5. The method of claim 3 wherein the health insurance carrier is allowed to recover damages from the health care provider only if a predetermined threshold level of negligence has occurred.

6. The method of claim 3 wherein at least a portion of damages recovered by said health insurance carrier is transferred to one of (a) said patient, (b) said patient's family, and (c) said patient's designee.

7. The method of claim 6 wherein said portion of damages is inversely proportional to incentives received by said patient for said subrogation/assignment.

8. The method of claim 5 wherein said threshold level of negligence is ordinary negligence.

9. The method of claim 5 wherein said threshold level of negligence is gross negligence.

10. The method of claim 1 wherein said health care provider receives from said health care insurance carrier an incentive to adhere to said practice guidelines.

11. The method of claim 10 wherein said incentive is selected from the group consisting of bonuses, additional compensation, and combinations thereof.

12. The method of claim 10 wherein said adherence is determined based on audit.

13. The method of claim 1 wherein said patient receives from said health care insurance carrier an incentive in exchange for said subrogation/assignment.

14. The method of claim 13, wherein said incentive includes a reduced health insurance premium.

15. The method of claim 13 wherein said incentive includes at least one of (a) a disability insurance policy, (b) a life insurance policy, and (c) a long-term care insurance policy.

16. The method of claim 13 wherein said incentive includes a subsidy for premium for one of (a) a disability insurance policy, (b) a life insurance policy, and (c) a long-term care insurance policy.

17. The method of claim 13 wherein said incentive comprises paid up health insurance premium for a predefined period of time when said patient suffers a covered injury by a health care provider.

18. The method of claim 13 wherein said incentive comprises paid up medical care for a predefined period of time when said patient suffers a covered injury by a health care provider.

19. The method of claim 13 wherein said incentive comprises a level of health insurance premium commensurate with said one of said defined levels.

20. The method of claim 1 wherein said patient is subject to a disincentive if said patient ignores terms of said subrogation/assignment.

21. The method of claim 20 wherein said disincentive is selected from the group consisting of liquidated damages, attorneys fees, denial of continued medical insurance coverage, and combinations thereof.

22. The method of claim 1 wherein said practice guidelines specify tests, therapies and recommendations for referrals established to maintain a standard of care to maintain at least one of a defined goal of patient safety, a defined level of diagnostic sensitivity, and a therapeutic goal for a specific medical condition.

23. The method of claim 22 wherein there is a gradation of defined levels of said practice guidelines.

24. The method of claim 23 further comprising offering to an insured an incentive for choosing one of said defined levels of said practice guidelines.

25. The method of claim 24 wherein said incentive comprises a level of health insurance premium commensurate with said one of said defined levels.

26. The method of claim 24 wherein said incentive comprises a level of subsidy, commensurate with said one of said defined levels, for a premium for one of (a) life insurance, (b) disability insurance, and (c) long-term care insurance.

27. The method of claim 24 wherein said incentive comprises paid up health insurance premium for a predefined period of time whose length is commensurate with said one of said defined levels.

28. The method of claim 24 wherein said incentive comprises paid up medical care for a predefined period of time whose length is commensurate with said one of said defined levels.

29. The method of claim 24 wherein said incentive comprises a guarantee of implementation of patient safety systems.

30. The method of claim 1 further comprising said health care provider agreeing to adhere to said practice guidelines.

31. Apparatus for deterring practice of defensive medicine by health care providers, said apparatus comprising:
a practice guideline unit for defining and disseminating practice guidelines for rendering medical care;
an issuing unit adapted to issue to a patient a plan of health insurance, including securing from said patient subrogation/assignment to said health care insurance carrier of any professional liability claim that arises against any health care provider;
a claims unit adapted to accept a report, from a covered patient, of a claim of injury resulting from alleged violation of said practice guidelines by a health care provider;
a claims review unit comprising an output and an input device, wherein:
for each report received of a professional liability claim from a covered patient:
said output device flags said report for review for making a determination of whether said health care provider adhered by said practice guidelines, and
on completion of said review, said determination is entered into said input device, said claims review unit further comprising:
a lawsuit authorization unit adapted to authorize a lawsuit against said health care provider when review of said claim results in a conclusion that said health care provider failed to adhere to said practice guidelines.

32. The apparatus of claim 31 wherein said issuing unit requires said health care professional to agree to adhere to said practice guidelines.

33. The apparatus of claim 31 further comprising a printer adapted to print a certificate evidencing coverage for each patient accepted for coverage under said plan of insurance.

34. The apparatus of claim 31 further comprising a disbursement unit adapted to disburse funds to said patient on the occasion of an award or settlement in said lawsuit.

35. The apparatus of claim 34 wherein said disbursement unit disburses funds a portion of said award or settlement according to a level of coverage purchased by said patient.
